(19) United States
(12) Patent Application Publication
(10) Pub. No.: US 2010/0145726 A1
(43) Pub. Date: Jun. 10, 2010

(54) Method and System for Providing a Patient Therapeutic Plan

(76) Inventors: David O. Duke, Arroyo Grande, CA (US); Janet K. Duke, Arroyo Grande, CA (US); Linda Byron-Alton, San Luis Obispo, CA (US); Joe Cockrill Jauregui, Charlotte, NC (US)

Correspondence Address: PASSE' INTELLECTUAL PROPERTY, LLC, 1717 BRASSFIELD RD., RALEIGH, NC, 27614, US

(21) Appl. No.: 12/329,754

(22) Filed: Dec. 8, 2008

(51) Int. Cl. G06Q 50/00; G06Q 90/00

(52) U.S. Cl. 705/3; 705/2

(57) ABSTRACT

The present invention relates to a system and method for providing a patient with a therapeutic plan and tracking the process of providing such therapeutic plan. In particular, the present invention relates to systems and methods for obtaining information from a patient, disseminating treatment information to a patient and health care provider, and aiding both in arriving at a therapeutic plan and documenting that interaction with the assistance of a digital assistance device.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a system and method for providing a patient with a therapeutic plan and tracking the process of providing such therapeutic plan. In particular, the present invention relates to systems and methods for obtaining information from a patient, disseminating treatment information to a patient and health care provider, and aiding both in arriving at a therapeutic plan and documenting that interaction with the assistance of a digital assistance device.

2. Description of Related Art

The provision of medical services, when reimbursements from insurance or from the government are involved, requires an ever increasing amount of reporting requirements to verify actions taken and to achieve minimum standards. Without adequate verification of the time spent and the approved items accomplished both the insurance and the government will frequently either not pay or pay at a reduced rate. However, it is frequently difficult for the busy medical practice to insure and document (the process of verification) that these requirements are being accomplished and that the appropriate amount of time is being spent with patients.

As one example, the US Medicare system requires specific quality reporting requirements to receive the full payment increases for Medicare payments for the provision of Medical services. Under the current Reporting Hospital Quality Data for Annual Payment Update (RHQDAPU) requirements, hospitals that do not meet the reporting requirements will be subject to a reduction of 1.3% in the payments received from Medicare. One of those requirements among the areas changed for reporting is the provision of medical counseling and treatment for the cessation of smoking by adult patients. In addition, health care providers such as physician's, physician's assistants and the like, must use a particular reimbursement structure to provide smoking cessation counseling and treatment. Currently, the minimum time to spend with the patient for receiving billing is 3 minutes with greater reimbursement available for spending more than 10 minutes. While the times spent can be made cumulative over multiple visits, the ability to provide this service and maintain some semblance of time has caused problems for the health care provider and his office. Due to Medicare being essentially the country's largest insurance provider for medical services many other health insurance companies base their payments on the Medicare system. Because the reporting requirements have become considerable difficult, actually reporting and collecting for these types of reimbursements has often resulted in becoming extremely challenging or next to impossible. Even then it is very difficult to accomplish and make enough money to make the process worthwhile.

Likewise, the providers of pharmaceuticals and other medical treatment systems desire to make both patients and health care providers aware of the treatment options available. Unfortunately, the need to spend less time getting more and more accomplished has led to a difficulty in providing both time and a means for educating the health care provider and patient with the available treatment regimens.

### BRIEF SUMMARY OF THE INVENTION

The present invention provides a system and method for providing not only assistance for certain treatment and counseling to patients, but it also provides a means for educating of both the consumer patient and health care provider about the treatment plan options in order for patient and the health care provider to make decisions on the course of a treatment plan together and be more fully educated. The present invention involves identification of a medical issue or condition by the system, the use of an electronic device for asking further questions of the patient and providing information to the healthcare provider and patient for deciding on a treatment. The electronic device is also able to track time spent for recording purposes and billing purposes and all the decisions or recommendations can be sent to other computers and record keeping devices for billing tracking purposes.

In an embodiment of the invention there is disclosed a method of providing medical service to a patient comprising:
a) identifying patient condition details in need of a therapeutic plan;
b) providing the patient with a digital interactive system, which asks the patient questions about the patient relating to the condition;
c) having the patient answer questions on the digital interactive system;
d) having the digital interactive system establish baseline data and therapeutic plan options from the answers;
e) transferring baseline data and therapeutic plan options to a health care provider; and
f) selecting a plan for implementation.

Yet another embodiment of the present invention relates to a system of providing medical service to a patient comprising:
a) a digital interactive system capable of communicating with a health service provider;
b) an interactive program available to the digital interactive system capable of asking and receiving patient's questions regarding one or more selected medical conditions and providing a health care provider one or more therapeutic plans to treat the medical condition based on answers received to the questions; and
c) means of tracking third party billing and documentation requirements for the patient and comparing them to a service being provided to the patient.

### BRIEF DESCRIPTION OF THE DRAWINGS

FIG. 1 is a flow chart of the general aspects of the method of the present invention.

FIG. 2 is a graphic representation of the system's relationship between the invention and its related parts.

FIG. 3 is a flow chart of a specific embodiment of the invention relating to smoking cessation.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the phrase “medical service” refers to health care service provided by a health care provider in an office, hospital or like setting. In other embodiments, medical service could even refer to providing service, via an electronic means or other communications, between a health care provider and patient. Health care providers include, where appropriate, a physician, or other health care professional such as a Physician Assistant, Nurse Practitioner, Dentist, Chiropractor, Pharmacist, alternative care provider or the like in an office, hospital or like setting, or even online or via phone or email consultation. In one embodiment it refers to any practitioner capable of prescribing medication or treatment. In some embodiments, the medication or treatment is prescription medication, while in other embodiments it is a non-prescription medication, a suggestion for behavioral modification, counseling or the like.

A patient condition in need of a therapeutic plan can include counseling and treatment for things like cigarette, alcohol and drug abuse cessation and treatment of medical conditions such as colds, injuries, obesity, diabetes, psychiatric illness, heart disease, cosmetic, holistic and natural treatments and the like. Anything that it is possible to begin to collect potential therapeutic plans, based on the collection of information from the patient, is contemplated within the scope of an embodiment herein.

As used herein, the term “patient” refers to anyone seeking services from a health care provider, from examination, to counseling, to procedures, treatments, and the like. It assumes that the patient may be seeing the health care provider in any setting from the health care provider's office to the emergency room, to the clinic, or electronically (phone, internet, etc) or the like. “Patient condition details” refers to those conditions identified previously, during initial patient triage, entered on the internet or during other interaction with the healthcare provider and the provider's staff. This triage may be in the form of a written or oral questionnaire, by observation or examination, and/or identified via interaction with the system. In one embodiment, the patient goes to the internet and answers a series of questions over the internet to begin the triage. In one embodiment, in the office, clinic or hospital setting, the patient arrives for the visit and the front desk or admitting area asks a series of questions to the patient regarding their health, conditions, the reason for the visit and other related questions such as, do you smoke, drink, abuse drugs or the like, and/or their goals. Standard medical triage questions, either very detailed or general, can be used. The condition in need of a therapeutic plan is one identified from the above process. Therefore, in one embodiment where the patient identifies that they are a smoker, the question of cessation of smoking may also be brought up by the patient or asked by the triage, thus identifying a condition in need of a therapeutic plan to quit smoking. Other types of patient conditions would include obesity, hypertension, pain, respiratory ailments, diabetes, and any condition for which treatment options exist which would benefit from greater information exchange and planning between patient and the health care provider. The system could also identify potential improvements to the patient's current treatment plan (e.g., such as highlighting potentially negative drug interactions and suggesting alternatives).

A “therapeutic plan”, as used herein, refers to the determination of a course of action in dealing with an identified patient condition. The plan may be to do nothing, select from a choice of pharmaceuticals or over the counter products (collectively medications), choices of surgery, therapy, continued counseling, or the like, or other therapeutic options, such as dental, nutritional counseling physical therapy, alternative treatments (holistic, herbal acupuncture, etc) and the like. The patient can have the opportunity in some embodiments to choose a therapeutic plan or at least make a preferred choice which can be reviewed by the health care provider. For example, if a patient shows preference for a particular therapeutic agent over another therapeutic agent (i.e., doesn't prefer a particular medication), the system will print out that preference for the health care provider (physician), however, it will also make note for the provider that a treatment option (such as a medication which the owner/licensor of the system desires to promote) can be appropriate, is not contraindicated, and list any additional benefits of the highlighted agent over the patient's initial preference.

As used herein, a “digital interactive system” refers to a computer or computer like interface. Examples are portable computers, PDAs, kiosks, cell phones (either directly or indirectly) and the like, that have either the internal computing power or can interact with a source of the information such as from a web site on the internet or a server computer. For the purposes of this invention it relates to any digital device (e.g. handheld, digital kiosk, etc) that can serve as a digital device for asking questions, recording the answers to the questions, and to calculating a therapeutic plan based on the input provided whether the digital device accomplishes that directly or indirectly, for example, by connection to a web site having such abilities, is all within the scope of the invention. A cell phone could receive a downloaded e-mail or the like, or a PDA could receive a set of questions or have the questions on the device itself. A key to the invention is that the patient has access to a device that can provide the questions, record answers and compute the meaning of the answers to the questions and transfer or transmit any other information to another device as well as give information about a treatment plan and the like to the patient. While a small hand held device like a palm pilot may be used, any computer type device may be used including a laptop, a computer kiosk or a custom designed hand held device manufactured specifically to handle the system of the present invention. While in one embodiment the device has uses in addition to the present invention, in other embodiments, the device is used solely for the present invention. As an example of an additional use, the digital device could be programmed with a means to identify or help a patient recall which medicines the patient has taken or is taking. Additional questions of a particular manner could be asked in a manner to help the patient remember. Simple answers such as “the little white pill for my heart” and asking more and more detailed questions as the choices are narrowed can be used to identify possibilities. Other choices would be to identify the frequency of taking the medication or even showing pictures of the medications could be used. This could be very useful in identifying previous medications that either worked or in some cases did not work for the patient.

Once the triage has been completed some form of that information is entered into or transferred to the digital interactive system. The digital interactive system then decides what set of preprogrammed questions, relating to the conditions, to ask in order to determine what the available treatments, therapies or the like are potentially available to the patient. The digital interactive system accomplishes this by asking further detailed questions to the patient and recording the answers on the digital interactive system, a web site or other computer. Once the question and answer session is completed the digital interactive system (or other source delivering to the digital interactive system) makes a determination of what information is relevant and compiles all the relevant information as the “baseline date”. Baseline data could include treatment plans, the answers to the questions, and conclusions about the questions or any other related patient information. It also then determines the “therapeutic plan options” or “therapeutic plans” which can be pharmaceutical or OTC drug treatments, therapies, to do nothing, surgery and the like.

Once the baseline data and therapeutic plan options are determined, the digital interactive device can then transfer that data to the physician or other health care workers as desired. The digital interactive system is also able to send suggested topics to cover with the patient that the physician can touch on as part of the counseling session. Things like diet, reasons for choosing to treat the condition, dangers of not treating and the like could be included. The transfer may be accomplished in any number of convenient ways. In one embodiment the baseline data and/or the therapeutic plans are sent to a printer to go on the patients chart. In another embodiment the information is transferred to a computer and placed in the patients file. This enables the physician to discuss the therapeutic plans, the topics, the choices and the like with the patient. For example, in one embodiment, where the patient's condition is smoking, the digital interactive system will determine the level of the smoking problem from the questions and answers. Thereafter the digital interactive system determines a series of appropriate stop smoking plans, pharmaceuticals and the like in the form of a list and transfers that information to the physician where the patient and physician can review the available therapeutic plan options and select one of the options for implementation.

The digital interactive system of the present invention may also serve a variety of other functions useful in providing service to a patient, including tracking requirements for third party providers and making sure the physician has accomplished those requirements in order to be reimbursed properly at the maximum permissible level. In the case of one embodiment of smoking cessation, the digital interactive system would keep track of the time spent with the patient and inform the physician how much more time would need to be spent with the patient in order to insure that either the 3 minute or 10 minute reimbursable time had been spent with the patient in order to qualify for reimbursement. It would also make sure that all the items that those requirements demand to be discussed with the patient are accomplished as well, by printing that information out to the patient's chart or to the physician for discussion with the patient at the exam or counseling session. In some embodiments the physician will counsel conditions such as smoking cessation, alcohol cessation, drug abuse cessation, and obesity.

In one embodiment, the digital interactive system can also generate the appropriate HCPCS/CPT codes for billing purposes to avoid oversight of potential problems. The digital interactive system would use the information on the counseling to optimize billing by tracking counseling or other examinations over multiple visits over a given time. The PDA can also follow up with patients, for example, by sending e mails with letters from the physician, reminders of additional appointments or any other related information regarding the counseling or the patient and physician relationship, and keep record of those interactions for the purpose of billing.

In another embodiment of the present invention, the PDA or other portable device could be equipped with an RFID system, or some other tracking tag/transmitter or the like. By including a tracking means in the device the PDA will not accidently be removed or stolen from the physician's office or misplaced due to careless personnel tracking. Further, the PDA could be programmed with a means to identify the patients only by secret PIN numbers, and/or the data encrypted, so that in the event a PDA is removed from the office or stolen or the patient explores the PDA, and the encryption is defeated, that patient's identity will be kept confidential, thus insuring patient confidentiality with the PDA device under all circumstances.

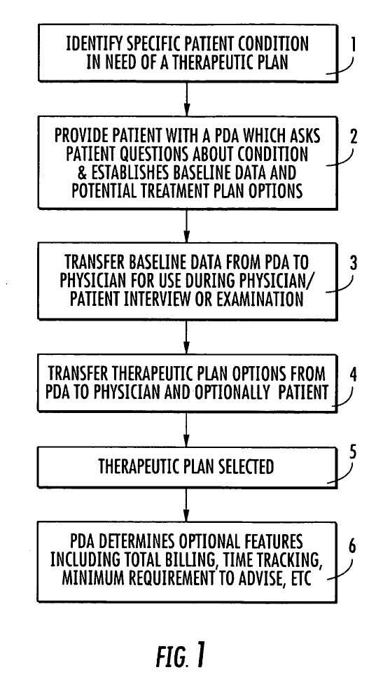

Now referring to the drawings FIG. 1 is a flow diagram of an embodiment of the method of the present invention. When a patient arrives at a location for a physician exam or counseling, such as at a hospital, the physician's office, a clinic, or initiates contact with the system electronically (e.g., interacts with a physician through the internet), or the like, the patient will check in and the patient will be identified. During the patient triage, interview or examination, the medical staff and or the system itself will determine the medical condition 1 in need of a therapeutic plan. This could be for example the treatment of smoking, alcohol or drug abuse or any other type medical condition.

Once the particular medical condition is identified 1 then the patient is provided with a PDA or other digital interactive system which is capable of asking the patient specific questions about the condition and then uses that information to establish a baseline data about the patient condition for which one or more potential treatment plans could be successfully used. The PDA can be a small handheld unit or can be a bigger handheld unit to enable the user to easily ready any text on the screen. So screen sizes are about 3, 6, 12 inches or greater in some embodiments (such as in a kiosk). The baseline data is that information which enables a decision by the system to determine the best plan or plans for dealing with the patient medical condition. For example, in the case of a patient who wishes to stop smoking the basic data may be how frequent and how long the patient has been smoking. How many cigarettes a day may also be important. Other questions may relate to other types of cessation plans that have been tried as well as particular allergies and the like.

Once the system has established the baseline data 2 the baseline data 2 is transferred to the physician 3 or other health care worker. In one embodiment a PDA is merely handed to the healthcare worker to accomplish the transfer. The transfer of the data can be accomplished by any convenient manner, for example, by sending the information to a printer, to another computer, to the patient's files and the like could be used. The baseline data can be used by the physician to help counsel the patient, explain the particular medical condition and the like to the patient so that the physician can avoid the long process of obtaining that information himself, thus saving time and money in treating the patient. This is especially important where third party reimbursement amounts are not adequate or require specific things be completed in the exam or counseling session. In yet another embodiment of the present invention system, the system need not be a specific device that resides in the health care provider's office or the like. The owner or licensor of the present system could advertise for and direct prospective patients to an offsite office, website, phone system or like means for communication with the patient. Therefore, while a device of the healthcare worker could be used, the patient's device could be involved such as the patients PDA or cell phone or the like. The system would then gather the necessary initial information from prospective patients either in person or electronically via phone internet or the like. After the data is collected and the prospective patient is informed, views, and/or listens to the provided information or advertisements, they can then be referred to a participating health care provider and the information gathered processed and transmitted to the participating health care provider. The health care provider would then counsel the patient based on the provided data, and then the data would be transmitted back into the system for further processing and use as described above.

In addition to the transfer of the baseline data from the PDA, the PDA will also transfer any therapeutic plan options it has determined viable to the physician 4. By sending the treatment options to the physician, the physician can make sure that all treatment possibilities are considered. In addition, where desirable, the patient can also view the therapeutic plan options directly on the PDA which gives the physician the ability to work with an informed patient. Also, the treatment plan can in some cases be determined by both the physician and patient together picking or even in some instances by the patient alone. In one embodiment wherein the treatment desired is the cessation of smoking, the patient could view several videos or other information on the PDA and use that information to make an informed choice. The PDA could provide information to the physician and patient from the manufacturer of the plan for example, a pharmaceutical company or the provider of a smoking cessation product. The information could be straight information or in the form of an advertisement for the treatment plan to the patient, the physician or both. In addition, information gathered from the patient could be gathered for use in medical and marketing research.

At the physician exam or consultation the therapeutic plan can be selected 5 for or by the patient. In the case of prescription items the physician can then act accordingly and prescribe the appropriate therapeutic plan for the patient.

The PDA can, in some embodiments, have optional features 6. Those features include billing for the process, tracking the minimum consultation requirements of time and the like to receive third party reimbursement, general time tracking and the like. Other features include writing and/or electronically sending prescriptions, helping the care provider analyze the patient's conditions, medications and allergies for potential negative interactions or improvements. In one embodiment, it can help identify a particular medication a patient is taking and has forgotten the name of, by a series of questions.

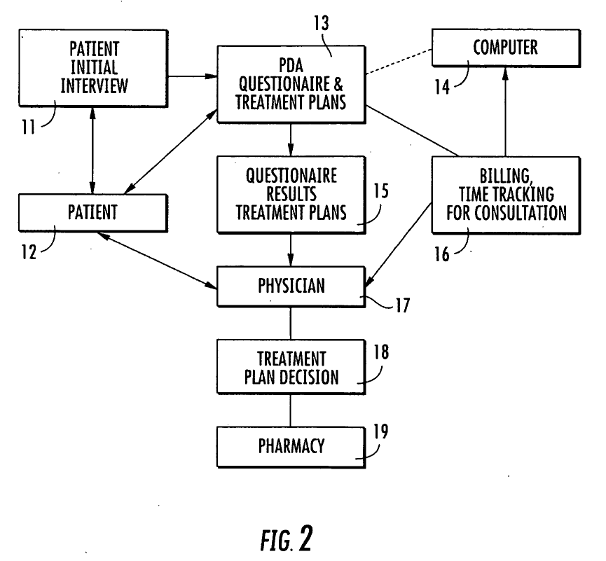

FIG. 2 is a diagram of an embodiment of the system's relationship of the present invention and its related parts. A patient 12 goes to a physician's office, an admission desk, a clinic or the like and has a patient initial interview 11 with the triage or front desk or the like. At that event the patient can give general information that can be used for the present invention. For example, in one embodiment, in the initial triage the patient says they are a smoker. At that point the initial interview 11 would have identified smoking as a medical condition for the present invention. Other conditions could be identified from the interview, such as described above, drug use, negative or positive medication interaction, or the like.

The patient 12 is then given a PDA with a questionnaire 13 prior to consulting or examination by the physician that relates to the medical condition identified in the triage interview. The questions would be ones that relate to more detailed information about the condition and the answers to the question help identify one or more treatment plans 15 that could be used in the treatment of the medical condition. Those answers could be from any source. The questions could be specifically designed for the PDA or be questions developed by a third party provider specifically for deciding on a treatment plan. Once the questionnaire 13 is completed the PDA uses that information to formulate a treatment plan 15 or plans based on the most likely ones to match the needs and success of the particular patient. Therefore, in one embodiment where the treatment is for cessation smoking questions might include the following:

1) Are you a smoker (tobacco user)?

2) Do you use any of these other tobacco products? (Chewing tobacco, Pipe, Snuff, Cigars),

3) How much do you smoke (how many times per day do you use it)?

4) How long have you smoked?

5) Does anyone in your household smoke?

6) After you wake up, how soon do you smoke your first cigarette/use tobacco?

7) Would you like to quit smoking?

8) How willing are you to quit (Rate 1-10)?

9) Over what time frame would you like to quit (immediately, over 1 month, 6 months, etc).?

10) Have you ever tried to quit?

11) Have you ever had success with any quitting method (write in, or choice of several)?

12) What method has not worked for you (choice of several)?

13) If you decided to stop completely in the next two weeks, how confident are you in your success?

14) Would you like information on medications which could help you quit?

15) Do you have any smoking related conditions (choice of several are given)?

16) Do you have any of these conditions (list conditions which would conflict with potential treatment)?

17) What medications do you currently take—is the list we have current, are there others (herbs, vitamins, OTC, etc.)?

18) Do you have allergies to any medications (is the list we have current, are there others)?

19) What is your family medical history (cardiac disease, cancer, psychosis, etc)?

20) Would it be ok to contact you by phone/email—what are your phone and email addresses?

21) Review of patient's insurance information, ability/willingness to pay for medication. potential suggestions could be made to the patient regarding insurance tailoring insurance to their needs and smoking coverage resources for obtaining Medicare if eligible avoiding the “donut hole”, etc.?

22) What are the top three issues you'd like to discuss with your doctor today:
List of possible smoking related issues [developed from the above questionnaire (or internal to the device)], or write in your question for your doctor.

Using this list, the doctor knows the top three things the patient is willing to discuss during this visit. Hitting on one every 1 minutes, gives 3+ minutes of counseling, and would likely attempt to meet the requirements for billing for reimbursement.

If patient has already participated with the system but on a subsequent visit does not complete a second interaction with the device, the device will still print out a list of things to discuss based on the next most important “top ten” things a patient identified during the previous session.

Other question examples could be included such as:
1) What pharmacy do you use?
2) Would you be willing to switch pharmacies, or use an online/home delivery option for all your medications?
3) Would receiving a valuable coupon make you want to switch pharmacies?
4) Would you like to review other medication choices that might work better for you rather than the current medications you receive?
5) Are you ever upset that your prescriptions are switched to less expensive generic versions without your consent? Would you like all your medications to be filled with the original name brand reliable medication? (conversely, the question could ask, “would you like to save money by switching to these cheaper generic alternatives?”).

The questions are designed to:

1) Include highlighted therapeutic agents and exclude contraindications,

2) Develop an appropriate secondary diagnosis relevant to smoking cessation counseling (e.g., emphysema) and billing,

3) Aid in marketing and therapeutic research,

4) Yield marketing data regarding patient's choice of therapeutic agent,

5) Obtain and report back on health care providers prescribing patterns, especially as they relate to specific patient scenarios,

6) The collected data could help in research on how to improve quitting rates (or other therapeutic goals),

7) Help the patient fill out the appropriate paperwork to qualify for their medication being approved and paid for, and

8) The device will also be useful in updating the patients list of medical conditions, history, medications and allergies.

The device could also ask other questions of relevance during the question and answer period such as:
1) Document patient's choice regarding potential therapeutic agents (i.e., John Doe requested a specific medication)
2) (on a subsequent visit) If the highlighted medication is already being used, the system will obtain marketing and research data as to why the choice was made, and how the patient is doing.

Once the treatment plans are decided upon the PDA can give information to the patient about them. It can merely list them, give detailed information about them, or in one embodiment, give videos or other presentations directly from the manufacturers of the particular treatment in the form of straight information or as an advertisement. Once the patient is finished with the PDA the information in the PDA about the patient can move in the system in a number of ways. One important thing the PDA can do is download the information to a computer 14. This can be an office computer, a server computer, another PDA, the internet or the like but in that way the information can be saved and transferred as needed by the physician and patient. The PDA can then via the computer or in other embodiments directly give the results to the physician 17 on the treatment plans selected. This activity saves the physician the time to gather this information in a conference but still enables enough time to be spent to work on getting reimbursement for third party providers especially when that provider is the government which might require a certain amount of time to qualify for reimbursement. The physician 17 and patient 12 then can interact by way of consultation and or examination to come to a decision 18 on which of the available treatment plans will be selected. The patient can then go to the pharmacy 19 or other product provider to acquire the necessary product to accomplish the treatment plan.

Note that the PDA can also communicate with the computer and the system either the PDA 13 or the computer 14 can accomplish various other tasks 16. For example the PDA can track billing from the activity because it can track the time spent in “consultation” with the device. It can also give reminders or warnings about things, such as, if more time needs to be spent with the patient to qualify for reimbursement or if any other particular activity required for reimbursement has not been achieved.

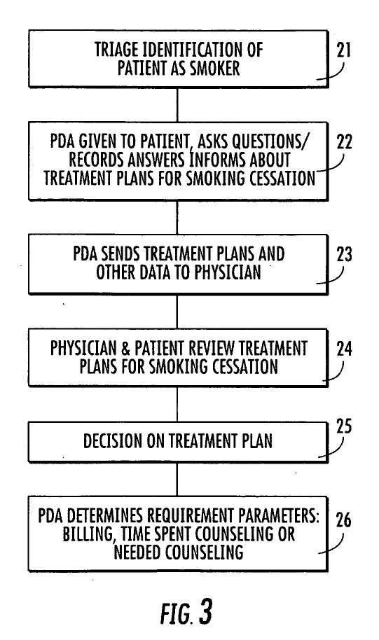

FIG. 3 details a specific example of the present invention relating to smoking cessation. As a patient enters the facility being a physician office, a clinic or the like the triage identifies the patient as a smoker 21. This can be accomplished by observation by questionnaire, or the like. Once the patient is identified as a smoker a PDA is given to the patient 22. The PDA has questions programmed into it about the patient's smoking habits and records the answers. The PDA then uses the answers to the questions to inform the patient about the available treatment plans for cessation of smoking 22 that match the patient and his particular smoking problem. Note that this could be in text or video or the like format. The companies which produce the smoking cessation products could each have their own information to program into the PDA for viewing by the patient or the system could provide the information separately from commercially available information. In addition, particular brands of products could be emphasized by particular companies providing information for the PDA to give the patient. By working with pharmaceutical or other companies to highlight their products directly at the time treatment is offered, the companies have a higher likelihood of their product being selected when choice is an option.

Once the PDA has informed the patient about the smoking cessation options 22, the PDA can send the treatment plan and other related baseline data (the answers to the questions, for example) to the Physician 23. This could be done by sending the information to a printer, a different computer for viewing or the PDA itself could be used by the physician. In other embodiments the results of the PDA consultation are printed or otherwise placed on the patients chart.

With the results of the PDA consultation with the patient 22 the physician and patient can review the suggested or recommended treatment plans for the cessation of smoking. This can be a review of what the patient has already seen, an opportunity to answer questions and discuss risks or whatever other information is necessary. If the PDA has given the Physician information about how much time to spend with the patient to qualify for third party reimbursement then that could be a guide as to how much time to spend with the patient.

With the finishing of the discussion 25 the next step is to come to a decision on the treatment plan 26. This decision can be made by the physician, the patient or both in terms of which treatment plan would most likely be successful with the particular patient having noted the answers to the particular questionnaire.

The PDA has other functions in the system as well analyzing reimbursement requirements, billing to the patient or third party provider, time spent in counseling, the need to provide additional counseling and recording of the process on the patient's chart either by printing the information out or transferring the information to the health care provider or health care provider's practice computer, or directly to the payor/billing company, etc.

Once the final decision is made the particular cessation product is purchased from a pharmacy. The PDA may also have the capability of sending the prescription to a given pharmacy of the physician or patient choosing. Where cooperative pharmacies are involved additional patient benefits may be obtained by using participating pharmacies.

It is clear from the description and figures herein that substitutions of both medical condition, types of electronic device and the like are within the scope of the present invention and the claims should be given broad interpretation and not otherwise be read as limiting.

What is claimed is:

1. A method of assisting a health care provider in providing a therapeutic plan to a patient without a therapeutic plan comprising:
a) identifying patient condition details in need of a therapeutic plan and providing the details to a digital interactive system;
b) providing patient with the digital interactive system, which asks patient questions about the patient relating to the condition for determining a therapeutic plan;
c) having the patient answering the questions on the digital interactive system;
d) having the digital interactive system establishing baseline data and therapeutic plan options from the answers provided by the patient;
e) transferring baseline data and therapeutic plan options on the digital interactive system to a health care provider; and
f) having the health care provider select a therapeutic plan from the digital interactive system for implementation to the patient.

2. A method according to claim 1 which further comprises the digital interactive system tracking the amount of time spent in the method for billing purposes.

3. A method according to claim 1 which further comprises the digital interactive system tracking the health care provider's time requirements necessary for reimbursement.

4. A method according to claim 1 wherein the physician service is a counseling service.

5. A method according to claim 4 wherein the counseling service is selected from the group consisting of, smoking cessation, alcohol cessation, obesity, high blood pressure and drug abuse cessation.

6. A method according to claim 1 wherein the digital interactive system sends the baseline data or the treatment plan options to a printer.

7. A method according to claim 1 wherein the digital interactive system sends the baseline data or the treatment plan options to a computer.

8. A method according to claim 1 wherein the digital interactive system notifies the physician when there has not been enough time spent in counseling the patient.

9. A method according to claim 1 wherein the digital interactive system provides the patient with information about the treatment plan options.

10. A method according to claim 1 wherein at least a portion of the patient condition details are programmed into the digital interactive system.

11. A method according to claim 1 wherein the digital interactive system provides information from a therapeutic plan manufacturer about the manufacturer's product.

12. A method according to claim 1 wherein the review of the therapeutic plan options includes a physical exam.

13. A method according to claim 1 wherein the digital interactive system determines methods to optimize billing time to meet a predetermined billing requirement.

14. A method according to claim 1 wherein the digital interactive system is equipped with a tracking system to prevent theft.

15. A method according to claim 1 wherein the digital interactive system identifies a patient for asking questions by a unique personal identification number.

16. A method according to claim 1 wherein the digital interactive system is an internet based system.

17. A system of providing medical service to a patient in need of a therapeutic plan comprising:
a) a digital interactive system capable of communicating with a health service provider;
b) an interactive program stored in a tangible medium for use by the digital interactive system capable of asking and receiving patient questions regarding one or more selected untreated medical conditions and providing the health care provider one or more therapeutic plans to treat the medical condition based on answers received to the questions; and
c) a digital program stored in a tangible medium for use by the digital interactive system for tracking third party billing and documentation requirements for the patient, comparing them to a service being provided to the patient and determining if the service is in compliance with the billing and documentation requirements.

18. A system according to claim 17 wherein the digital interactive system is capable of presenting the therapeutic plans to the patient.

19. A system according to claim 17 wherein the digital interactive system is capable of being updated with third party billing and documentation requirements.

20. A system according to claim 17 which further comprises a system for assisting the patient to identify medications they are taking.

21. A system according to claim 17 wherein the digital interactive system is an internet based system.
